(19) United States
(12) Patent Application Publication
(10) Pub. No.: US 2015/0113588 A1
(43) Pub. Date: Apr. 23, 2015

(54) Firewall Limiting with Third-Party Traffic Classification

(71) Applicant: Cisco Technology, Inc., San Jose, CA (US)

(72) Inventors: Daniel Wing, San Jose, CA (US); Tirumaleswar Reddy, Bangalore (IN)

(73) Assignee: Cisco Technology, Inc., San Jose, CA (US)

(21) Appl. No.: 14/059,853

(22) Filed: Oct. 22, 2013

(51) Int. Cl. H04L 29/06

(52) U.S. Cl. CPC H04L 63/0227
USPC 726/1

(57) ABSTRACT

A PCP-aware firewall or other firewall validating a media session using third-party authorization receives more information than just the results of cryptographic token validation. The intent for each media stream of a media session is received from the Authorization Server. The intent may be used to compare to the received traffic of the media session. If the traffic is different than the intended traffic, then the exception to permit the firewall may be closed.

### TECHNICAL FIELD

This disclosure relates in general to the field of computer networks and, more particularly, to limiting traffic through a firewall using third-party traffic classification.

### BACKGROUND

To establish a media session between a peer within an enterprise and a peer outside of the enterprise, a firewall of the enterprise is configured to allow the media session. The firewall may inspect the traffic for the media session, such as a media streams (e.g., voice and/or audio) or data channels to secure the enterprise. For example, the firewall includes an Application Layer Gateway (ALG) function for security. However, ALG may operate for a single connection between the peers, but media using the session initiation protocol (SIP) may establish multiple connections for a given media session.

Enterprise firewalls would typically have granular policies to permit calls initiated using selected or trusted SIP, WebRTC, or both servers and block calls from other servers. The problem is associating the peer-to-peer media session with the signaling session. The current technique used by Firewalls to solve the problem is ALG

A firewall may implement a SIP-aware Application Layer Gateway function, which examines the SIP signaling to that SIP proxy and opens the appropriate pinholes for the media session. However, examining the SIP signaling may not work where the session signaling is end-to-end encrypted between peers, preventing examination of the SIP signaling. If the firewall does not understand the session signaling protocol or extensions to the protocol, examination is prevented. For example, WebRTC does not enforce a particular session signaling protocol; therefore, the firewall is unlikely to understand the signaling protocol. Examination may be prevented where the session signaling and media traverse different firewalls of the enterprise (e.g., signaling exits a network via one firewall whereas media exits a network via a different firewall).

Firewall protection may be enhanced with port control protocol (PCP) aware firewalls. In PCP, the client communicates with an OAuth Authorization Server (e.g. SIP or WebRTC server) to obtain a cryptographic token for the media flow. That token is included in the PCP request. The PCP controlled firewall communicates with the authorization server in order to validate the token and obtain token-bound data. However, an authorized source may still pass undesired information through the firewall.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts.

FIG. 1 is a simplified block diagram of an example network for firewall limiting with third-party classification;

FIG. 2 is a diagram of one embodiment of a method for operating a PCP-aware firewall;

FIG. 3 is a flow chart diagram of one embodiment of a method for firewall limiting with third-party classification;

FIG. 4 shows example classification information provided to a PCP-aware or other firewall; and

FIG. 5 is a block diagram of a network device, according to one embodiment, for firewall limiting with third-party classification.

### DESCRIPTION OF EXAMPLE EMBODIMENTS

A PCP-aware firewall or other firewall validating a media session using third-party authorization receives more information than just the results of cryptographic token validation. The intent for each media stream of a media session is received from the Authorization Server. The intent may be used to compare to the received traffic of the media session. If the traffic is different than the intended traffic, then the exception to permit the firewall may be closed.

In one aspect, a method is provided where a firewall requests, from an authorization server, token validation and intent for 5-tuples (e.g., source IP address, destination IP address, protocol number, source port number, and destination port number) of a media session. The firewall server receives, from the authorization server, authorization for the media session and the intent for the 5-tuples associated with the media session. The firewall server creates a policy for the media session. The policy is a function of the intent. Traffic for the media session through the firewall server is monitored for a violation of the policy. The traffic is blocked when there is a mismatch between the traffic and the policy.

In another aspect, logic is encoded in one or more non-transitory computer-readable media that includes code for execution and when executed by a processor is operable to perform operations. The operations include transmitting a token to a first peer in response to a request from the first peer, the token corresponding to a media session from the first peer; receiving from a firewall the token and a request for expected characteristics of the media session; validating the token received from a firewall; and providing the expected characteristics of the media session to the firewall.

In yet another aspect, an apparatus includes a memory and a firewall processor. The memory is configured to store expected characteristics of a media session between at least two peers. The firewall processor is configured to obtain the expected characteristics of the media session from an authorization server, to establish pinholes for the media session, and to verify that the traffic for the media session satisfies the expected characteristics.

In PCP-aware firewall operation, temporary permission to create explicit mappings for a media session is provided by a trusted third party authorization server. An Internet protocol (IP) flow through a firewall is permitted by a remote authorization server. The authorization server may be in a separate administrative domain. This treats an IP flow as a resource, which is authorized by a separate or third-party server. A token is used by the authorization server to permit the temporary permission.

The temporary permission granted to the PCP client (e.g., peer) by the PCP-controlled firewall may be used by the client to send data for some other purpose than a call, like sending Bittorrent traffic. Deep packet inspection (DPI) may be used to limit data sent for other purposes than the call, but DPI may be insufficient. DPI may have problems dealing with end-to-end encryption. Transport layer security (TLS) may prevent inspection of the signaling protocol used. Not knowing the signaling protocol used between the peers may prevent signaling packet inspection. Use of different firewalls for session signaling and the peer-to-peer media may limit the effectiveness of DPI.

To address the difficulties, intent is used for a PCP-aware firewall. In addition to validating the token, the PCP-aware firewall requests the authorization server to provide the details of the expected flows. Details are provided for each 5-tuple of the media stream. For example, various details like the number of media streams, type of traffic for each stream (e.g., audio, video, or data), synchronization source (SSRC) for each media stream, RTP payload type (PT), number of data channels, and/or application identification (e.g., Skype). The PCP-capable firewall may create dynamic policies from the characterization of the expected data to police the media streams explicitly permitted by of the third party authorization. The PCP-controlled firewall inspects the traffic for any violations of the intent (i.e., characterization) and may take appropriate action for any misuse.

The use of the intended characteristics of the traffic for each connection allows the PCP-controlled firewall to monitor a media session without DPI of the signaling traffic. The PCP-controlled firewall in communication with the authorization server is aware of the intent of each 5-tuple stream created from the client and thus ensures that the client does not misuse the permission granted to create explicit mappings in the firewall. The firewall is able generate sys-logs, and Internet protocol flow information export (IPFIX) records with more detailed information like 5-tuple, identity details (USERNAME, REALM or domain) learnt from PCP authentication, L7 protocol details like audio, video, and data channel learnt from the authorization server, SIP, WebRTC, or both server domain name from which the call is initiated learnt using the token validation process, or other information from the same or different sources.

This limiting of the firewall based on intent or other characterization of the expected traffic is applicable to IPv4 or IPv6 firewalls. In the embodiments discussed below, the firewall is a PCP-aware firewall.

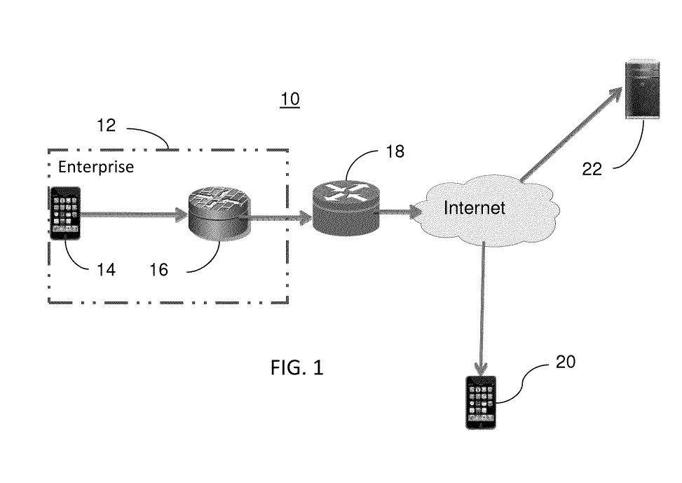

FIG. 1 shows an example network 10 for firewall limiting with third-party classification. A media session between end-point devices 14, 20 or peers is created through the firewall 16 using intent information provided by a third-party server 22. Additional, different, or fewer components may be provided in the network 10, such as additional end-point devices to participate in a given media session, additional third-party servers, no Internet service provider 18, or different networks.

The network 10 includes the enterprise network 12 connected to other servers and/or networks, such as the Internet service provider 18, the third-party authorization server 22, and the end-point device 20. The enterprise network 12, Internet service provider 18, and third-party server 22 include various network devices. The enterprise network 12 is shown including the end-point device 14 and the firewall 16, but may include additional components, such as routers, other end-point devices, and/or additional firewalls 16. The enterprise network 12 connects with or is part of the broader network 10. The firewall limiting with third-party classification operates on the firewall 16 of the enterprise network 12 in conjunction with an external third-party server 22. The enterprise network 12 connects through wires or wirelessly with other networks, such as the Internet.

The enterprise network 12 is shown as a box, but may be many different devices connected in a local area network, wide area network, intranet, virtual local area network, the Internet, or combinations of networks. Any form of network may be provided, such as transport networks, data center, or other wired or wireless network. The network 12 may be applicable across platforms, extensible, and/or adaptive to specific platform and/or technology requirements through link-negotiation of connectivity.

The network devices (e.g., end-point device 14 and firewall 16) of the enterprise network 12 are in a same room, building, facility or campus. In other embodiments, the enterprise network 12 is formed with devices distributed throughout a region, such as in multiple states and/or countries. The enterprise network 12 is a network owned, operated, and/or run by or for a given entity, such as the Cisco network for corporate operations.

The network devices are connected over links through ports. Any number of ports and links may be used. The ports and links may use the same or different media for communications. Wireless, wired, Ethernet, digital subscriber lines (DSL), telephone lines, T1 lines, T3 lines, satellite, fiber optics, cable and/or other links may be used. Corresponding interfaces are provided as the ports.

The Internet service provider 18 is a server or network that is part of or accessible through the other network or networks. The Internet service provider 18 is implemented by one or more servers outside of the enterprise network 12. The Internet service provider 18 provides connectivity of the enterprise network 12 to one or more other networks, such as the Internet.

Any number of end-point devices 14, 20 may be provided. The end-point devices 14, 20 are computers, conference servers, tablets, cellular phones, wifi capable devices, laptops, mainframes, voice-over-Internet phones, or other user devices participating in a media session. The end-point devices 14 within the enterprise network 12 connect with wires, such as Ethernet cables, or wirelessly, such as with wifi. The connection may be relatively fixed, such as for personal computers connected by wires to switches. The connection may be temporary, such as associated with mobile devices that access the enterprise network 12 as needed or when in range.

The end-point device 14 is configured to initiate or participate in a media session. The end-point device 14 operates pursuant to a real-time protocol (RTP) or other communications protocol for video and/or audio communications with or without data sharing. As part of the media session, content from another source may be added or incorporated. For example, data from one or more authorized sources, such as a financial services server, search engine, drop box database, or other source, is to be included in the media session. The web content is requested pursuant to TCP/IP or other protocol.

One of the participating end-point devices 14, 20 draws the information from the third party. For example, the requested content is located on the authorization server 22. The data may be drawn or obtained from a server other than the authorization server 22 and/or may be stored or accessed at the end-point device 14, 20 themselves.

The third party server 22 is implemented by one or more servers outside of the enterprise network 12. For example, the third-party server 22 is a SIP, WebRTC, or both server. The third-party server 22 is a source of content and/or a source of media session authentication. The third-party server 22 is part of a network or is a device trusted by the enterprise network 12. A token is generated or acquired by the third-party server 22 and used for creating mappings for a media session and/or for providing data to be used in an existing media session.

The firewall 16 is a server, edge router, or cloud connector. Other network devices may be used, such as a gateway or bridge. The firewall 16 is a processor device that limits access to the enterprise network 12. Data is processed by the firewall 16, such as limiting communications in general, limiting types of data, limiting sources of data, establishing pinholes or allowed communications, or otherwise securing the enterprise network 12. The firewall 16 communicates with the end-user device 14, the Internet service provider 18, and/or the third-party server 22. The communications are direct or indirect, such as being routed through other devices. For the two endpoint devices 14, 20 to successfully establish a media session, the firewall 16 permits interactive connectivity establishment (ICE) connectivity checks and subsequent media traffic.

The various components of the network 10 are configured by hardware and/or software to provide firewall limiting using third-party characterization of the expected traffic for a media session. Logic is encoded in one or more non-transitory computer-readable media for operating the firewall 16, end-point device 14, end-point device 20, and/or third-party server 22. The media is a memory. Memories within or outside the enterprise network 12 may be used. The logic includes code for execution by a processor or processors, such as processors of the firewall 16. When executed by a processor, the code is used to perform operations for firewall control or limiting access for media sessions. The logic code configures the device to perform operations.

The firewall 16 and the third-party server 22 are configured to interact. The interaction provides a characterization of expected traffic (e.g., intent) on one or more connections for the media session between the end-point devices 14, 20. This intent is used by the firewall 16 as an alternative or in addition to deep packet inspection to verify that traffic being attempted to pass through the firewall 16 into the enterprise network 12 is acceptable. Where the traffic is of a different type than expected, then the pinhole through the firewall for the media session may be blocked.

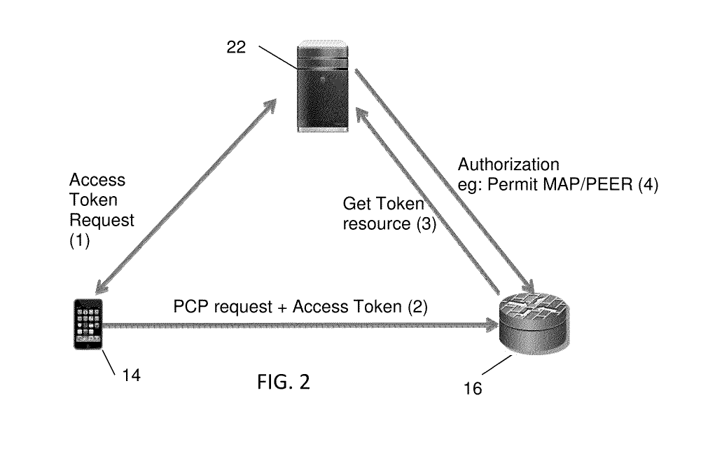

FIG. 2 shows interaction between the end-point device 14 of the enterprise network 12, the firewall 16, and the third-party server 22 for PCP-based operation. A cryptographic token is used to avoid blocking encrypted traffic, signaling of the traffic with an unknown protocol, and traffic traversing different firewalls 16. This PCP-based operation may also be used to provide intent or other characterization of the expected traffic of the media session to avoid abuse of the temporary access through the firewall provided by the PCP-based operation.

The end-point device 14 requests a token from the third-party server 22 to start a media session or to access data during a media session. In one embodiment, the end-point device 14 acting as a PCP client makes a PCP request without any authorization. If the firewall 16 acting as a PCP server returns an error or other message, the PCP client concludes that the PCP server is mandating the use of third party authorization. The PCP client then obtains a cryptographic token from the third-party server 22 acting as an Oauth 2.0 server. Alternatively, the end-point device 14 requests the token without first attempting access to data through the firewall 16 without the token.

Using the OAuth 2.0 authorization framework, a PCP client obtains limited access to a PCP server on behalf of the SIP, Web RTC, or both server. The PCP client requests access to resources controlled by the resource owner (SIP, WebRTC, or both server). The PCP client obtains an access token, lifetime, and other access attributes, like the PCP options and opcodes that the PCP client is permitted to use from the authorization server. The third-party server 22 provides the cryptographic token.

The PCP client sends a PCP request including the cryptographic token to the firewall (PCP server). In response to the PCP request, the PCP server uses the token to perform third party authorization.

The PCP server communicates with the authorization server in order to validate the token and obtain token-bound data. The PCP server makes a request to the authorization server to validate the token but produces no other data with the request. If the token is successfully validated, the authorization server returns the token bound authorization data in the response. The PCP server then matches this authorization data with what is requested in the PCP request sent by the PCP client. If the authorization sets match, the PCP server honors the PCP request made by the PCP client. If the token is invalid or the request exceeds what is authorized by the token, then the PCP server generates an error response. An example might be that an OAuth authorization server permits creating 5 mappings, and the PCP request made by the client is trying to create a 6th mapping.

Other checks may be performed to allow creation of a pinhole by the firewall. When a PCP request is received, the received timestamp is checked and the cryptographic token is accepted if the timestamp is recent enough. If the timestamp is not within the boundaries, then the PCP request is discarded as invalid.

A PCP-controlled firewall 16 with restrictive policies may also want to validate with the authorization server if the selected candidate pairs in the final offer/answer match the 5-tuple {destination address, source address, protocol, destination port, source port} sessions traversing the firewall 16. This validation ensures that the PCP client is using the token only to send and receive the media streams finalized in the call to the remote peer. Thus, the PCP server makes sure that the token cannot be used for anything else. If PCP authentication is used, then the PCP server may also validate with the authorization server if the access token is issued and used by the same user or not.

This technique can also be used by a PCP-capable network address translation (NAT) to permit a MAP request from the PCP client so that the client may learn the External IP Addresses and Ports using a MAP request/response. If server reflexive candidates learnt using session transversal utilities for NAT (STUN) and External IP addresses/Ports learnt using PCP are different, then the candidates learnt via PCP are encoded in the ICE offer and answer just like the server reflexive candidates. This technique may be used by any other application function trusted by the network to permit time-bound, encrypted, peer-to-peer traffic.

Another approach is a self-contained token where all the information necessary to authenticate the validity of the token is contained within the token itself. Other authentication or PCP-based approaches may be used. Different verifications may be provided.

To ensure that the permissions given to the PCP client to create explicit mappings for the media session is used by the PCP client only to send appropriate media streams, the firewall also uses intent information provided as part of or with the token or the validation. In addition to the token and 5-tuple information discussed above, a characterization of the expected media stream for each 5-tuple is provided. This characterization or intent may be used to compare with the actual traffic received. Where the actual traffic has a characteristic different from the expected characteristic, the firewall may block the traffic.

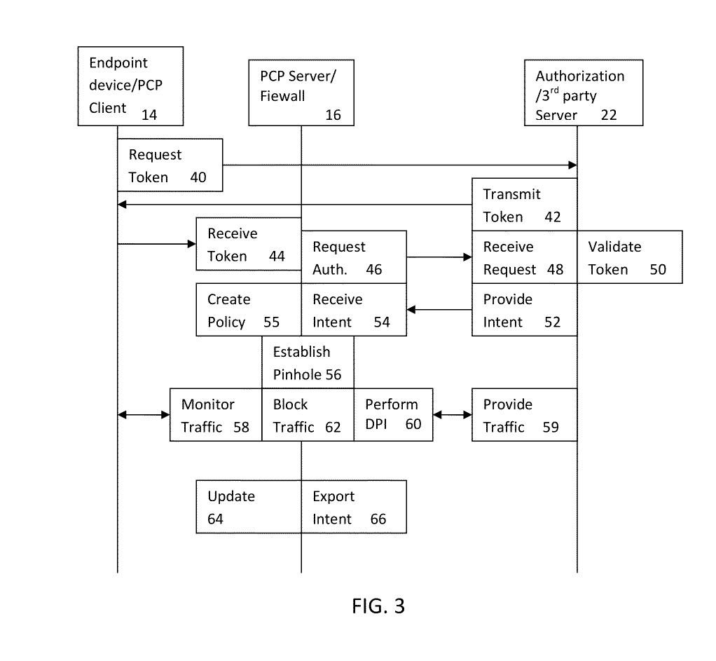

FIG. 3 shows one embodiment of a method for firewall limiting with third-party classification. The method is implemented in the context of the PCP-based token authentication of FIG. 2. The classification is provided as intent with or as part of the token or validation. The firewall or PCP server uses the classification information for one or more verifications implemented after establishing the pinhole or access through the firewall. In other embodiments, the intent is provided in a non-PCP environment, such as providing the intent from a third-party server without the token or token validation.

Additional, different, or fewer acts may be provided. For example, the request for the token of act 40 and the transmission of a token in response in act 42 are not provided. The token is instead resident on the PCP client of the end-point device 14. As another example, the update of act 64 and/or the export of the intent in act 66 are not provided. The acts are performed in the order shown (top to bottom) or a different order.

In act 40, the end-point device 14 requests a token from the authorization server 22. Alternatively, the firewall 16 requests a token to be sent to the end-point device 14 in response to a request for media session access from the end-point device 14. Any request format may be used. In one embodiment, the PCP-based approach for requesting the encrypted token is used.

The request may include one or more characteristics of the media session or an indication of the data to be acquired and used as part of the media session. The request indicates information that may be used by the authorization server 22 to create the intent or otherwise characterize the media session associated with the token.

In act 42, the authorization server 22 transmits the token to the end-point device 14. The token is transmitted in response to the request. The token is a cryptographic token. Any cryptographic token may be used.

The authorization server 22 creates the cryptographic token, such as by encrypting a message responsive to the request or based on the data or characteristics of the data to be provided. Alternatively, the authorization server 22 obtains the token from another source.

The token is linked to the media session to be established or already established. The link may be by header information or may be by encrypted content of the token. A reference to the particular media session involved is included. Other information may be included with or in the token, such as intent information.

The end-point device 14 transmits the token with a PCP request to the firewall 16. In act 44, the firewall 16 receives the request and the token. In act 46, the firewall requests token validation from the authorization server 22. The authorization server 22 receives the request for token validation in act 48.

The authorization server 22 and firewall 16 in the enterprise 12 have a business agreement, such as having mutual authentication between them. The trust association helps to permit authorized applications and deny unauthorized applications. For example, the PCP server is configured with domain names of trusted authorization servers 22 and has certificates for mutual authentication. The relationship may be provided in static networks or dynamic networks, such as for mobile networks.

The request from the firewall 16 to the authorization server 22 also includes or itself indicates a request for intent. Both token validation and intent for the media session are requested and/or are to be provided.

The intent is requested for a 5-tuple of the media session. Where the media session includes multiple 5-tuples, intent for each is requested. Alternatively, the intent for only one, fewer than all, or a sub-set of the 5-tuples is requested. For example, the authorization server 22 hosts some but not all content to be provided in the media session, so intent is provided only for the 5-tuples associated with the hosted content.

The intent is a characterization of the connections of the media session. Each 5-tuple is provided for a specific connection. The connection has characteristics or expected characteristics. The expected traffic of the media session is characterized. The intent of the traffic for each connection may be used to compare with actual traffic.

For example, the intent may be a type of media stream. A given 5-tuple may be for audio, another for video, another for data, and another for signaling. The traffic may be checked to see if the traffic conforms to the expected type of media stream for a given 5-tuple.

As another example, the intent may be of a RTP payload type. Video, audio, and data may be compressed or processed in more than one way. For example, various audio codecs are available. By indicating the type of codec, compression, or other processing used, the payload type is provided.

In yet another example, the application identification is provided as intent. Different applications may be used for media sessions. Skype, Webex, or other applications are identified. The characteristics associated with the application or specific identification of the application in the traffic may be used to verify proper traffic.

In another example, intent is a synchronization source identifier, such as SSRC. SSRC indicates the source of information. The header of the RTP indicates the SSRC. SSRC may be used in case the SSRC is explicitly signaled in the signaling protocol (e.g., in the session description protocol (SDP)). The source is a characteristic of the media session that may be verified.

Another example of intent is the 5-tuple for RTCP. A 5-tuple may be established for feedback in the media session. The feedback may indicate the number of packets, delayed packets, missed packets or other information useful for statistics and control of real-time communications. This 5-tuple may be used to verify that data being sent is part of the media session.

Yet another example of intent is the number of data channels. The media session includes one or more data channels. The expected number of data channels is provided.

Other characterizations of the media session may be used. Combinations of two or more of the characterizations may be used, such as using the payload type, media type, and application identification.

In act 50, the authorization server 22 validates the token in act 50. The token received from the firewall 16 is compared to the token provided to the end-point device 14. A match validates the token. Any cryptographic validation may be used.

In act 52, the validation and the expected characteristics of the media session (e.g., intent) are provided to the firewall 16 by the authorization server 22. The authorization server 22 provides details about the purpose of each 5-tuple to the firewall 16. This intent is provided in addition to providing the number of media and data channels. For example, the type of media stream, a source synchronization (SSRC), a type of RTP payload, a real-time control protocol (RTCP) 5-tuple, application identifier, or combinations thereof for the media stream are provided.

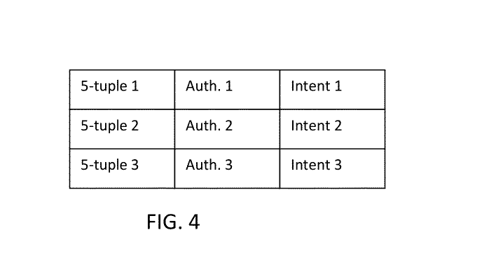

In act 54, the firewall 16 receives the authorization for the media session and the intent from the authorization server 22. FIG. 4 shows an example message received by the firewall 16. The message is for a media session that includes three connections or 5-tuples. Fewer or more connections may be provided for a given media session. For each 5-tuple, separate authorization and intent are provided. In alternative embodiments, the authorization and/or intent for one 5-tuple may be the same as for other 5-tuples, such as a single authorization applying to all of the connections for a given media session.

The authorization is an indication of validation. The token received from the firewall 16 matches the token provided to the end-point device 14.

The intent is received for each, some, or one of the 5-tuples. The type of media and/or other characteristic of the expected traffic for each connection are received by the firewall 16 from the authorization server 22. Alternatively, the intent is received for the media session. Each connection of a media session may be compared against the generic intent.

The intent and authorization are received in response to a request. As shown in FIG. 3, a request-response operation is used for communicating the intent. In alternative embodiments, a publication-subscription (pubsub) mechanism is used. The PCP-controlled firewall 16 registers or subscribes with the authorization server 22, so that the firewall 16 is notified of any changes or initial intent in the call by the authorization server 22. The changes in the call may be for authorization and/or intent.

In act 55, the firewall 16 creates a policy for the media session. A policy is generic to the media session and/or separate policies are created for each 5-tuple or connection of the media session. Where connections are with different firewalls 16, the firewalls 16 create policies specific to the connections handled by the respective firewall 16.

The created policy is a function of the intent. In one embodiment, the policy is the intent. The intent of the traffic is stored, such as in a table, for comparison with actual traffic. In another embodiment, the intent is used to look-up or cross-reference specific information. For example, a codec name or reference provided as a payload type is used to determine a characteristic (e.g., packet size, frequency, rate or other characteristic of a data stream). The characteristic or characteristics are set as the policy. Other policy creation may be used.

The policy is created dynamically based on the information received from the authorization server 22. The policy is used by the firewall 16 to police the traffic to verify if the L7 traffic matches the expected properties of the flow of traffic.

In act 56, a pinhole is established for the firewall 16. The firewall 16 uses mappings of 5-tuples to allow data for the media session into and from the enterprise network 12. The pinhole is one or more connections of allowed traffic between peers or end-point devices 14, 20 of the media session. Any firewall pinhole process may be used.

In act 58, received traffic is monitored. The traffic for the media session is received by the firewall 16. The traffic is from either endpoint device 14, 20 For example, data or other content is provided from the authorization server 22 for use in the media session or to be shared with both end-point devices 14, 20. The data or other content for the end-point device 14 in the enterprise passes through the firewall 16.

The traffic is monitored for a violation of the policy. For example, Layer 7 traffic of the media session is monitored.

To monitor, one or more checks are performed. One of the checks is based on the intent policy. Other checks may be used. For example, the traffic is validated in two ways. First, the PCP-controlled firewall 16 checks if the number of connections or media streams created by the endpoint device 14 matches the number of connections or media streams finalized in the call provided by authorization sever 22.

Second, the PCP-controlled firewall 16 validates if the permitted traffic matches the intent provided by the authorization server 22. One or more characteristics of the traffic are compared to the intent-based policy. The policy dictates expected or allowable characteristics. Where the actual characteristics of the traffic match the expected characteristics, the traffic is allowed to pass.

Any characteristics may be compared. For example, the type of media stream, RTP payload types, application identity, SSRC, and/or other characteristics are compared.

The characteristics may be found without knowing the protocol, with the data encrypted, or with different connections through different firewalls. For example, the properties of the traffic (audio, SSRC, application identity, payload type, or combinations thereof) may be extracted from a RTP header without having to decrypt the RTP data. As another example, the data may be processed or filtered to measure a characteristic (e.g., codec used) even though decrypted or of an unknown protocol. Similarly, the characteristic is determined for unencrypted data of a known protocol.

The monitoring may include a separate deep packet inspection in act 60. The intent-based policy monitoring may occur without deep packet inspection, but may be performed as part of deep packet inspection. Any deep packet inspection may be used, such as deep packet inspection of the payload of unencrypted or decrypted data of a known protocol.

In act 62, traffic is blocked where there is a mismatch between the traffic and the intent-based policy or other monitoring functions. For example, a 5-tuple is intended to be used for audio traffic. If video traffic or non-audio data traffic is received by the firewall 16 on that connection, the intent is violated. Different payload type (e.g., different codec), different application identity, different SSRC, and/or different 5-tuple for real-time control protocol (RTCP) may violate the policy. Violating traffic is blocked. If the PCP-controlled firewall 16 detects that there is a mismatch between expected characteristics and actual characteristics, then the firewall 16 blocks the traffic.

Traffic not violating the policy may be allowed. Alternatively, all traffic on a connection or through a pinhole is blocked once a violation occurs. The firewall 16 informs the authorization server 22 of the violation and requests revocation of the token. If required, a quarantine or other appropriate action is taken against the host or source of the violating traffic.

In other embodiments, one or more mechanisms are used to destroy an established media session. Four example mechanisms are revoking the token, deleting a pinhole of the firewall server, re-authenticating, or deleting mappings for the media session. To delete the pinhole, the PCP client (e.g., end-point 14) explicitly requests the PCP server (e.g. firewall 16) to delete the explicit mapping by setting the “Requested lifetime” to 0 in PCP MAP request. To revoke the token, the authorization server 22 requests that the PCP server (e.g., firewall 16) revoke the access token after the flow is terminated. This mechanism ensures that even if the PCP client does not close the dynamic mapping created, the PCP server based on the revocation notification from the Authorization Server may close the mapping. For re-authentication, the PCP authentication is used. The PCP server triggers re-authentication before the security association (SA) expires. If the client does not respond after N tries, then PCP server deletes the mappings, assuring that the PCP client could have crashed or terminated or connection is lost for some reason or the user has logged off. For deleting mappings, the firewall 16 and NAT may use L4 mapping timers to remove idle sessions.

In act 64, updates may occur during a media session. The firewall 16 updates protocol information, intent, or other information for the media session. The update may be started by the firewall 16, the authorization server 22, or the end-point devices 14, 20. If a change to the configuration of the media session occurs, the intent and corresponding policy may be updated.

In one embodiment, the update may be based on the traffic of the media session. ICE connectivity checks matching the explicit mapping created using PCP MAP message may be permitted, and the flows may be initially classified by the firewall 16 as UDP. When the actual data is exchanged between the peers (e.g., end-points 14, 20) based on the intent provided by authorization server 22 and policing of UDP traffic, the firewall 16 updates the L7 protocol details to reflect if the flow is used for audio/video streams or data channels. Other characteristics may be updated.

The update is for changing the media session and corresponding intent-based policy. In other embodiments, the update is for recording data about the media session. In act 66, the intent is exported to a netflow collector. The expected and/or actual characteristics of the traffic of the media session are obtained and provided for analysis. For example, the firewall 16 obtains various meta-data, like the application identity, from the authorization server 22. The firewall 16 exports the gathered information to the netflow collector for network analytics.

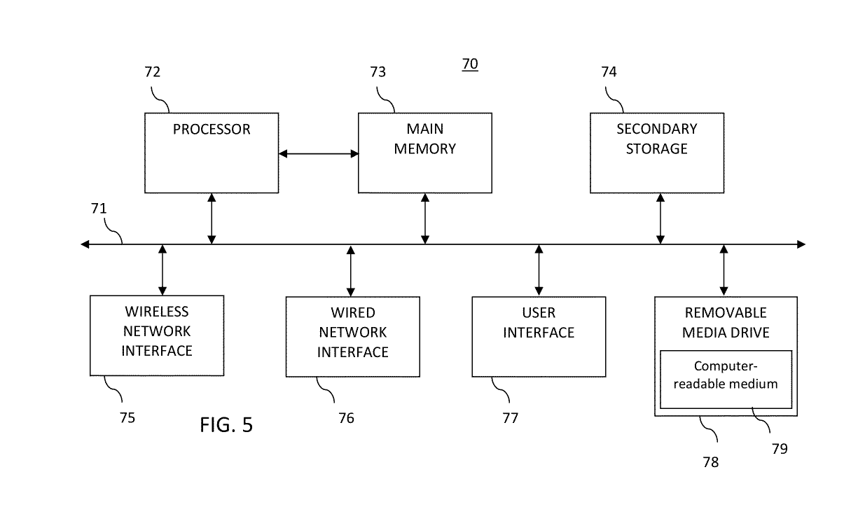

FIG. 5 shows one embodiment of an apparatus for firewall limiting based on intent from a third-party. The apparatus is shown as a simplified block diagram of an example network device, such as the end-point device 14, firewall 16, or authorization server 22 of FIG. 1. In FIG. 5, the example network apparatus or device 70 corresponds to network elements or computing devices that may be deployed in the network 12 or network 10. The network device 70 includes software and/or hardware to perform any one or more of the activities or operations for firewall operation using third-party authorization to classify traffic.

The network device 70 includes a processor 72, a main memory 73, secondary storage 74, a wireless network interface 75, a wired network interface 76, a user interface 77, and a removable media drive 78 including a computer-readable medium 79. A bus 71, such as a system bus and a memory bus, may provide electronic communication between processor 72 and the other components, memory, drives, and interfaces of network device 70.

Additional, different, or fewer components may be provided. The components are intended for illustrative purposes and are not meant to imply architectural limitations of network devices 14, 16, 22. For example, the network device 70 may include another processor and/or not include the secondary storage 74 or removable media drive 78. Each network device 14, 16, 22 may include more or less components than other network devices 14, 16, 22.

The processor 72, which may also be referred to as a central processing unit (CPU), is any general or special-purpose processor capable of executing machine readable instructions and performing operations on data as instructed by the machine readable instructions. The main memory 73 may be directly accessible to processor 72 for accessing machine instructions and may be in the form of random access memory (RAM) or any type of dynamic storage (e.g., dynamic random access memory (DRAM)). The secondary storage 74 may be any non-volatile memory, such as a hard disk, which is capable of storing electronic data including executable software files. Externally stored electronic data may be provided to computer 70 through one or more removable media drives 78, which may be configured to receive any type of external media 79, such as compact discs (CDs), digital video discs (DVDs), flash drives, external hard drives, or any other external media.

The wireless and wired network interfaces 75 and 76 may be provided to enable electronic communication between the network device 70 and other network devices via one or more networks. In one example, the wireless network interface 75 includes a wireless network interface controller (WNIC) with suitable transmitting and receiving components, such as transceivers, for wirelessly communicating within the network 10. The wired network interface 76 may enable the network device 70 to physically connect to the network 10 by a wire, such as an Ethernet cable. Both wireless and wired network interfaces 75 and 76 may be configured to facilitate communications using suitable communication protocols, such as the Internet Protocol Suite (TCP/IP).

The network device 70 is shown with both wireless and wired network interfaces 75 and 76 for illustrative purposes only. While one or both wireless and hardwire interfaces may be provided in the network device 70, or externally connected to network device 70, only one connection option is needed to enable connection of network device 70 to the network 10. The network device 70 may include any number of ports using any type of connection option.

A user interface 77 may be provided in none, some or all machines to allow a user to interact with the network device 70. The user interface 77 includes a display device (e.g., plasma display panel (PDP), a liquid crystal display (LCD), or a cathode ray tube (CRT)). In addition, any appropriate input device may also be included, such as a keyboard, a touch screen, a mouse, a trackball, microphone (e.g., input for voice recognition), buttons, and/or touch pad.

Instructions embodying the activities or functions described herein may be stored on one or more external computer-readable media 79, in main memory 73, in the secondary storage 74, or in the cache memory of processor 72 of the network device 70. These memory elements of network device 70 are non-transitory computer-readable media. The logic for implementing the processes, methods and/or techniques discussed herein are provided on non-transitory computer-readable storage media or memories, such as a cache, buffer, RAM, removable media, hard drive or other computer readable storage media. Computer readable storage media include various types of volatile and nonvolatile storage media. Thus, ‘computer-readable medium’ is meant to include any medium that is capable of storing instructions for execution by network device 70 that cause the machine to perform any one or more of the activities disclosed herein.

The instructions stored on the memory as logic may be executed by the processor 72. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like.

Additional hardware may be coupled to the processor 72 of the network device 70. For example, memory management units (MMU), additional symmetric multiprocessing (SMP) elements, physical memory, peripheral component interconnect (PCI) bus and corresponding bridges, or small computer system interface (SCSI)/integrated drive electronics (IDE) elements. The network device 70 may include any additional suitable hardware, software, components, modules, interfaces, or objects that facilitate operation. This may be inclusive of appropriate algorithms and communication protocols that allow for the effective protection and communication of data. Furthermore, any suitable operating system is configured in network device 70 to appropriately manage the operation of the hardware components therein.

As a firewall server, one or more of the memories 73, 74, 79, or another memory stores expected characteristics of a media session between at least two peers. A type of media stream, a source synchronization identifier, a type of payload, a real-time control protocol 5-tuple, application identifier, or combinations thereof for the media stream are stored. Alternatively or additionally, the policy or policies derived from the expected characteristics are stored.

The processor 72, configured by logic or other instructions, obtains the expected characteristics of the media session from a server outside the enterprise network 12. In one embodiment, the processor 72 is PCP-aware. The expected characteristics for each of a plurality of 5-tuples for the media session are obtained. One or more pinholes or explicit mappings are created for the media session. When traffic is received, the processor 72 verifies that the traffic for the media session satisfies the expected characteristics. The verification is performed for each of the 5-tuples. The actual characteristics of the traffic are compared to the expected characteristics with or without also performing deep packet inspection. The verification may occur even for encrypted data or signaling of an unknown protocol. For example, the RTP header is in clear text and includes various fields, like SSRC and RTP Payload type. The payload may be encrypted for confidentiality. The Firewall inspects (e.g., using a deep packet inspection functionality) the RTP header to match against the information provided by the authorization server.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. A method comprising:
requesting, by a firewall server from an authorization server, token validation and intent for a 5-tuple of a media session;
receiving, by the firewall server from the authorization server, authorization for the media session and the intent for the 5-tuple for the media session;
creating, by the firewall server, a policy for the media session, the policy being a function of the intent;
monitoring traffic for the media session through the firewall server for a violation of the policy; and
blocking the traffic when there is a mismatch between the traffic and the policy.

2. The method of claim 1 wherein requesting intent comprises requesting a type of media stream as audio, video, or data channel, and wherein receiving comprises receiving the type for the 5-tuple.

3. The method of claim 1 wherein requesting intent comprises requesting a type of media stream as audio, video, or data channel, synchronization source, payload type, 5-tuple for a real time control protocol, number of data channels, an application identifier, or combinations thereof.

4. The method of claim 1 wherein receiving the intent comprises receiving the intents for each of a plurality of 5-tuples associated with the media session.

5. The method of claim 1 wherein creating comprises storing the intent as the policy.

6. The method of claim 1 wherein monitoring the traffic comprises monitoring un-encrypted layer 7 traffic of the media session using a firewall inspection functionality.

7. The method of claim 1 wherein monitoring comprises comparing a characteristic of the traffic to the policy.

8. The method of claim 7 wherein monitoring comprises comparing a type of media stream, a payload type, application identity, or combinations thereof to the policy.

9. The method of claim 1 wherein blocking the traffic comprises blocking when the traffic is of a different type of media stream, different payload type, different application identity or combinations thereof than expected according to the intent.

10. The method of claim 1 wherein blocking the traffic comprises revoking the token, deleting a pinhole of the firewall server, re-authenticating, or deleting mappings for the media session.

11. The method of claim 1 further comprising:
receiving a token from a first end-user processor, the token originating from the authorization server;
establishing a pinhole for the firewall server for the media session between the first end-user processor and a second end-user processor separated by the firewall server;
including information from the authorization server in the media session between the first and second end-user processors.

12. The method of claim 1 further comprising performing deep packet inspection of the traffic.

13. The method of claim 1 further comprising updating, by the firewall server, protocol information for the media session, the updating being based on the traffic of the media session.

14. The method of claim 1 further comprising exporting the intent to a netflow collector.

15. Logic encoded in one or more non-transitory computer-readable media that includes code for execution and when executed by a processor is operable to perform operations comprising:
transmitting a token to a first peer in response to a request from the first peer, the token corresponding to a media session from the first peer to the firewall;
receiving from a firewall, the token and a request for expected characteristics of the media session;
validating the token received from a firewall; and
providing the expected characteristics of the media session to the firewall.

16. The logic encoded in the one or more non-transitory computer-readable media of claim 15, wherein providing the expected characteristics comprises providing a type of media stream, a source synchronization identifier, a type of payload, a real-time control protocol 5-tuple, application identifier, or combinations thereof for the media stream.

17. An apparatus comprising:
a memory configured to store expected characteristics of a media session between at least two peers; and
a firewall processor configured to obtain the expected characteristics of the media session from a server, to establish a pinhole for the media session, and to verify that the traffic for the media session satisfies the expected characteristics.

18. The apparatus of claim 17 wherein the expected characteristics comprise a type of media stream, a source synchronization identifier, a type of payload, a real-time control protocol 5-tuple, application identifier, or combinations thereof for the media stream.

19. The apparatus of claim 17 wherein processor is configured to verify that actual characteristics of the traffic match the expected characteristics without deep packet inspection of the signaling protocol.

20. The apparatus of claim 17 wherein the processor is configured to obtain the expected characteristics for each of a plurality of 5-tuples for the media session and is configured to verify for each of the 5-tuples.
